(19) United States
(12) Patent Application Publication
(10) Pub. No.: US 2026/0290787 A1
(43) Pub. Date: Sep. 24, 2026

(54) METHODS FOR INCREASING POROSITY IN CARBON-SILICON ELECTRODES

(71) Applicant: Alliance for Energy Innovation, LLC, Golden, CO (US)

(72) Inventors: Nathan Richard NEALE, Denver, CO (US); Trevor Russell MARTIN, Boulder, CO (US); Tyler James SWEET, Arvada, CO (US)

(21) Appl. No.: 19/570,994

(22) Filed: Mar. 18, 2026

Related U.S. Application Data
(60) Provisional application No. 63/774,422, filed on Mar. 19, 2025.

(51) Int. Cl. H01M 4/134; C01B 32/05; C01B 33/021; H01M 4/02; H01M 4/1395; H01M 4/38

(52) U.S. Cl. CPC H01M 4/134; C01B 32/05; C01B 33/021; H01M 4/1395; H01M 4/386; C01P 2002/01; C01P 2004/64; C01P 2006/16; H01M 2004/021

(57) ABSTRACT

The present disclosure relates to a composition that includes a plurality of aggregated particles of silicon nanoparticles embedded within a matrix. In some embodiments of the present disclosure, the aggregated particles may be characterized by a structure comprising a continuous peripheral body defining a central recess. In some embodiments of the present disclosure, the matrix may be carbonaceous. In some embodiments of the present disclosure, the aggregated particles may be porous.

### CROSS-REFERENCE TO RELATED APPLICATIONS

This application claims the benefit of U.S. Provisional Application No. 63/774,422 filed Mar. 19, 2025, the contents of which are incorporated herein by reference in their entirety.

### CONTRACTUAL ORIGIN

This invention was made with government support under Contract No. DE-AC36-08G028308 awarded by the Department of Energy. The government has certain rights in the invention.

### BACKGROUND

Battery anodes constructed of nanoscale silicon and carbonaceous materials have demonstrated promising capacity retention over the course of up to 1000 cycles. However, these anodes are often characterized by poor rate capabilities at areal loadings of greater than 2 mAh/cm². This is at least partially due to silicon-carbonaceous composite materials having extremely low porosities (about 20% or lower). Thus, there remains a need for improved methods for producing silicon-carbon composite electrodes having significantly higher porosities, as both new electrodes off the assembly line and after being subjected to repeated cycling.

### SUMMARY

An aspect of the present disclosure is a composition that includes a plurality of aggregated particles of silicon nanoparticles embedded within a matrix, where a portion of the aggregated particles is characterized by a structure comprising a continuous peripheral body defining a central recess. In some embodiments of the present disclosure, the matrix may be carbonaceous. In some embodiments of the present disclosure, the aggregated particles may be porous.

In some embodiments of the present disclosure, the central recess may impart a cup-like structure, a bowl-like structure, or a combination thereof to the aggregated particles. In some embodiments of the present disclosure, the continuous peripheral body may have an irregular profile, an oblong profile, or a combination thereof. In some embodiments of the present disclosure, the continuous peripheral body may have an average maximum outer dimension between 0.1 μm and 25 μm or between 0.5 μm and 1.5 μm. In some embodiments of the present disclosure, the central recess may have an average maximum outer dimension between 0.1 μm and 5 μm or between 0.1 μm and 0.5 μm. In some embodiments of the present disclosure, the central recess may extend entirely through the continuous peripheral body to form a central aperture.

In some embodiments of the present disclosure, the silicon nanoparticles may be substantially spherical and have an average diameter between 1 nm and 100 nm, between 5 nm and 50 nm, between 5 nm and 30 nm, or between 10 nm and 15 nm. In some embodiments of the present disclosure, the composition may have a silicon to carbon ratio on a weight basis between 1:1 and 50:1, between 70:30 and 95:5, between 1:3 and 1:25, or between 1:4 and 1:9. In some embodiments of the present disclosure, the composition may have an average porosity between 0 vol % and 80 vol %, between greater than 0 vol % and 80 vol %, between 5 vol % and 75 vol %, or between 10 vol % and 50 vol %.

An aspect of the present disclosure is an electrode that includes a layer of a mixture that includes aggregated particles positioned on a conductive metal plate, where the layer has a thickness between 1 μm and 100 μm or between 1 μm and 10 μm. In some embodiments of the present disclosure, the mixture may further include an additive of at least one of a dispersant, a binder, a thermally conductive additive, an ionically conductive additive, an electrically conductive additive, or a combination thereof. In some embodiments of the present disclosure, the conductive metal of the conductive metal plate may include at least one of copper, gold, silver, molybdenum, aluminum, titanium, or a combination thereof.

In some embodiments of the present disclosure, the electrode may be characterized by an areal loading between 0.8 mg/cm² and 1.25 mg/cm² or between 0.98 mg/cm² and 1.19 mg/cm². In some embodiments of the present disclosure, the electrode may be characterized by a specific capacity of the electrode at C/10 over a restricted voltage range from 50-650 mV vs. Li⁺/Li between 1000 mAh/g and 1500 mAh/g or between 1100 mAh/g and 1390 mAh/g. In some embodiments of the present disclosure, the electrode may be characterized by a specific capacity normalized to Si at C/10 over a restricted voltage range from 50-650 mV vs. Li⁺/Li between 1400 mAh/g Si and 1700 mAh/g Si or between 1510 mAh/g Si and 1649 mAh/g Si. In some embodiments of the present disclosure, the electrode may be characterized by a silicon utilization at C/10 between 75% and 99% or between 83% and 90%. In some embodiments of the present disclosure, the electrode may be characterized by a 6 C capacity retention relative to C/10 between 30% and 70% or between 51% and 61%.

An aspect of the present disclosure is a method that includes combining silicon nanoparticles and a precursor to form a first mixture, where the combining results in the forming of aggregated particles constructed of the silicon nanoparticles embedded in a matrix derived from the precursor. In some embodiments of the present disclosure, the method may further include, during the combining and/or after the combining, heating the silicon nanoparticles and the precursor to a temperature between 20° C. and 800° C., between 20° C. and 500° C., between 300° C. and 500° C., between 80° C. and 300° C., or between 20° C. and 250° C. In some embodiments of the present disclosure, the first mixture may further include a solvent and the combining may result in the forming of at least one of a slurry, a solution, or a combination thereof, prior to the forming of the aggregated particles. In some embodiments of the present disclosure, the combining may further include directing the first mixture through a first nozzle.

### DRAWINGS

Some embodiments are illustrated in referenced figures of the drawings. It is intended that the embodiments and figures disclosed herein are to be considered illustrative rather than limiting.

FIG. 1 illustrates a method tested to study the feasibility of a route for synthesizing aggregated particles, according to some embodiments of the present disclosure.

FIG. 2A illustrates transmission electron microscopy (TEM) images of starting silicon nanoparticles, according to some embodiments of the present disclosure. Panel (a) illustrates starting plasma-enhanced chemical vapor deposition (PECVD) derived silicon nanoparticles, and Panel (b) illustrates the silicon nanoparticles after coating with a polymer to form the aggregate

FIG. 2B illustrates a cross-sectional scanning electron microscopy (SEM) image of an electrode comprised of aggregated particles synthesized using the method illustrated in FIG. 1, according to some embodiments of the present disclosure.

FIG. 2C illustrates scanning electron microscopy (SEM) cross-sectional images comparing electrodes made from silicon nanoparticles having no cross-linking (no aggregated particle formation—top panel) with silicon nanoparticles having cross-linking (with aggregated particle formation—bottom panel), according to some embodiments of the present disclosure.

FIG. 3 illustrates a comparison of cell performance data obtained from a half-cell using the aggregated particles synthesized using the method illustrated in FIG. 1, according to some embodiments of the present disclosure.

FIG. 4 illustrates SEM cross-sectional images of non-aggregated PECVD Si electrode, according to some embodiments of the present disclosure.

FIG. 5 illustrates SEM images of ball milled aggregated particles, according to some embodiments of the present disclosure.

FIG. 6 illustrates SEM plan-view images of electrodes made from ball milled aggregated particles, according to some embodiments of the present disclosure.

FIG. 7 illustrates SEM images of spray dried aggregated particles, according to some embodiments of the present disclosure.

FIG. 8 illustrates SEM image of spray dried aggregated particles showing its toroidal morphology, according to some embodiments of the present disclosure.

FIG. 9 illustrates SEM plan-view images of electrodes made from spray dried aggregated particles, according to some embodiments of the present disclosure.

FIG. 10 illustrates symmetric rate capability test comparing normalized capacity of ESD electrode with a polyacrylic-acid-based binder versus non-aggregated Dense electrode at various C-rates, according to some embodiments of the present disclosure.

FIG. 11 illustrates symmetric rate capability test comparing normalized capacity of two different types of ESD electrodes (labeled ESD and cPAN) with a polyacrylic-acid-based binder versus non-aggregated Dense electrode at various C-rates, according to some embodiments of the present disclosure.

FIG. 12 illustrates rate capability of electrodes made from non-aggregated, ball milled, and ESD PECVD Si Anode Active Material (AAM), according to some embodiments of the present disclosure.

### DETAILED DESCRIPTION

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The present disclosure relates generally to methods for manufacturing composite materials and compositions resulting from such methods, in particular, aggregated particles that include silicon nanoparticles embedded within a matrix. In some embodiments of the present disclosure, aggregated materials may include nano-sized silicon particles embedded in a carbonaceous material. In some embodiments of the present disclosure, aggregated particles may be characterized by unique toroidal shapes with sizes between 0.1 μm and 50 μm. In some embodiments of the present disclosure, aggregated particles may be relatively dense with minimal porosity, while in other embodiments of the present disclosure, aggregated particles may be characterized by the presence of significant porosity, including macropores (pores with diameters greater than 50 nm), mesopores (pores having a diameter between 2 nm and 50 nm) and/or micropores (pores having a diameter less than 2 nm). As shown herein, such aggregated particles may be especially suited for use as silicon-based active materials in rechargeable lithium-ion batteries by providing the sufficient and correct type of active material size and morphology, which dictates electrode porosity, needed for reversible lithium-ion mass transfer through the active material and electrolyte, respectively, while also providing the robustness needed to minimize long-term mechanical, chemical, and/or electrochemical failure that often occurs in incumbent materials.

In some embodiments of the present disclosure, the central recess may impart a cup-like structure, a bowl-like structure, or a combination thereof to the aggregated particles. In some embodiments of the present disclosure, the continuous peripheral body may have an irregular profile, an oblong profile, a football-like morphology, a starfruit-shaped morphology, a whiffleball-like morphology, a hollow sphere morphology, or a combination thereof. In some embodiments of the present disclosure, the central recess may have an average maximum outer dimension between 0.5 μm and 50 μm. In some embodiments of the present disclosure, the maximum outer dimension may be between 0.1 μm and 25 μm. In some embodiments of the present disclosure, the central recess may have an average maximum outer dimension between 1 μm and 10 μm. In some embodiments of the present disclosure, the maximum outer dimension may be between 0.5 μm and 5 μm. In some embodiments of the present disclosure, the central recess may extend entirely through the continuous peripheral body to form a central aperture.

As shown herein, the methods for making aggregated particles may include a variety of steps and materials, thereby providing the flexibility needed to produce a wide variety of aggregated particles having specific physical properties and/or performance metrics. In turn, this flexibility enables a manufacturer to produce a wide array of aggregated particles that may be used in a variety of final products and/or devices, such as, for example, electrodes for rechargeable lithium batteries.

A simple example of a method for producing aggregated particles, in its broadest sense, is one that begins with the combining of silicon nanoparticles and a precursor to form a mixture. In some embodiments of the present disclosure, the step of combining silicon nanoparticles and a precursor may result in the formation of aggregated particles.

An important aspect of the process of making aggregated particles made of silicon nanoparticles embedded in a matrix is the silicon nanoparticles themselves. As shown herein, silicon nanoparticles may be tailored to have a variety of physical characteristics, depending on the requirements of downstream processing steps and/or final product performance metrics. In some embodiments of the present disclosure, silicon nanoparticles may have a substantially spherical shape, although other shapes are also possible such as cubes, rods, and wires.

In some embodiments of the present disclosure, silicon nanoparticles may have an average particle size, e.g., diameter for the example of a spherical shape, between 1 nm and 100 nm, between 5 nm and 50 nm, between 5 nm and 30 nm, or between 10 nm and 15 nm. In some embodiments of the present disclosure, the shape and/or physical properties of silicon nanoparticles may be controlled by the upstream method used to synthesize them. For example, silicon particles may be synthesized by plasma-enhanced chemical vapor deposition (PECVD). PECVD may be used to prepare intrinsic silicon nanoparticles and/or doped and/or alloyed silicon nanoparticles (e.g., containing boron (B), phosphorus (P), aluminum (Al), and/or manganese (Mn), etc.). Further, silicon nanoparticles used to synthesize aggregated particles may include at least one of a single crystalline phase, a polycrystalline phase, and/or an amorphous phase.

Further, in some embodiments of the present disclosure, starting silicon particles may have a core-shell morphology, in which the core is constructed of silicon surrounded by a shell that may include at least one of a molecule, a polymer, a polymer-derived coating, or a combination thereof. In some embodiments of the present disclosure, a shell may include polyethylene oxide (PEO), an oligomer of PEO, or a combination thereof. In some embodiments of the present disclosure, a shell may enable the silicon nanoparticles to be dissolved and/or dispersed in a liquid as described in more detail below.

As described herein, a precursor may provide the source material for the eventual matrix. In some embodiments of the present disclosure, a precursor may include at least one of a polymer, an oligomer, a monomer, a small molecule, or a combination thereof. Polymer precursors include nonconductive polymers, ionically conductive polymers, electrically conductive polymers, or combinations thereof. Examples of polymer precursors include polyimide, polyacrylonitrile (PAN), a polyphenylmethylimine (polyPMI), a polythiophene, or a combination of these. An example of a polythiophene is poly(3,4-ethylenedioxythiophene) polystyrene sulfonate (PEDOT:PSS). Examples of monomer precursors and small molecules include benzene dicarboxaldehyde, benzene-1,3,5-tricarboxaldehyde, p-phenylenediamine, an alkyl aldehyde, or a combination of these. Examples of alkyl aldehydes include hexanal, octanal, decanal, and/or dodecanal.

In some embodiments of the present disclosure, a mixture may be formulated with a specific weight ratio of silicon nanoparticles to precursor. For example, this ratio may be between 1:1 and 50:1 or between 70:30 and 95:5. Further, a mixture may also include one or more additives, with examples including a dispersant, a binder, a thermally conductive additive, an ionically conductive additive, an electrically conductive additive, or a combination thereof. Examples of an electrically conductive additive include carbon nanotubes, carbon black, and/or graphene.

The combining of silicon nanoparticles and a polymer precursor may be performed using a variety of mechanical methods, for example, ball-milling, jet milling, stirred media milling, immersion milling, cryo-milling, ultrasonic milling, or a combination thereof. In some embodiments of the present disclosure, a mechanical treatment using for example, ball-milling, may be used to achieve size-reduction of a starting batch silicon particles, in the absence of a polymer precursor. The resultant silicon particles may then be used in a subsequent combining step.

In some embodiments of the present disclosure, a method of making aggregated material may also include a heating step, which may occur during the combining of the materials, after the combining, or both. In some embodiments of the present disclosure, heating may result in raising the temperature of silicon nanoparticles and/or a precursor to a final temperature between 20° C. and 800° C., between 20° C. and 500° C., between 300° C. and 500° C., between 80° C. and 300° C., or between 20° C. and 250° C. This heating may, for example, result in the polymerization and/or thermal breakdown of the precursors and/or the thermal breakdown of the resultant polymer to form a carbonaceous material, such that the aggregated particles are constructed of a carbonaceous matrix with the silicon nanoparticles embedded therein. Thermal breakdown may be partial or complete. In some embodiments of the present disclosure, a polymer precursor may include polyacrylonitrile (PAN), where the heating results in the cyclization of the PAN, with or without the formation of the carbonaceous material depending on the temperatures attained during the heating step. As described in more detail below, heating may include a solid mixture of silicon nanoparticles and a precursor or, for the example of adding a solvent, heating may be performed on a slurry and/or solution. For this example, the resultant mixture, slurry and/or solution, may be heated to a relatively low temperature, between greater than 20° C. and 100° C.

Thus, a combining step and/or heating step may also utilize a liquid phase such as a solvent. The addition of a liquid phase to nanoparticles and/or a precursor may result in the formation of a mixture in the form of a slurry, a solution, or a combination thereof. Among other things, such a mixture may enable the transfer of the silicon nanoparticles and/or precursor to downstream unit operations for the eventual formation of the targeted aggregated particles. Solvents may be characterized by their vapor pressure. In some embodiments of the present disclosure, a solvent may have a vapor pressure between 0.04 kPa and 100 kPa, or between 0.1 kPa and 50 kPa, or between 0.13 kPa and 20 kPa, as measured at 20° C. Specific examples of solvents that may be used include water, N-methyl-pyrrolidone (NMP), N,N-dimethylacetamide (DMAc), N,N-dimethylformamide (DMF), dimethoxysulfoxide (DMSO), 1,2-dimethoxyethane (DME, glyme), diethylene glycol dimethyl ether (diglyme), triethylene glycol dimethyl ether (triglyme), tetrahydrofuran (THF), other ethers, ethylene glycol, glycerin, toluene, m-cresol, ortho-chlorophenol, chloroform, pyridine, acetonitrile, or combinations thereof.

In some embodiments of the present disclosure, the formation of aggregated particles may include a spraying step. For example, a mixture of silicon nanoparticles, a precursor, and a solvent, in the form of a slurry and/or solution, may be directed through a first nozzle to create a spray. In some embodiments of the present disclosure, the flow of the mixture through the first nozzle may result in a pressure drop across the first nozzle between 100 kPa and 2,000 kPa, between 1,000 kPa and 1,700 kPa, between 400 kPa and 1,000 kPa, between 140 kPa and 400 kPa, or between 40 and 140 kPa. For the example of supplying a mixture to a first nozzle, the mixture may be provided at a temperature between 20° C. and 100° C.

In some embodiments of the present disclosure, spraying may further include a second nozzle such that the first nozzle is positioned concentrically within a second nozzle. Further, a first gas may be directed through the second nozzle, resulting in the combining of the first gas with the mixture and the atomizing of the mixture to form an atomized mixture. The combining of the first gas with the mixture may occur as the two fluid streams impinge upon each other in the direct vicinity of both nozzles' outlets. In some embodiments of the present disclosure, a first gas may be an inert gas, such as nitrogen, helium, argon, or a combination thereof. In some embodiments of the present disclosure, a first gas may also include oxygen, air, carbon dioxide, and/or hydrogen, or a combination thereof. In some embodiments of the present disclosure, a first gas may be provided to the second nozzle at a temperature between 20° C. and 250° C.

Further, in some embodiments, an electrical voltage potential may be applied across the first nozzle, the second nozzle, or a combination thereof, resulting in an electrospray system. This voltage potential may be, for example, between 0.1 kV and 100 kV. In other examples, the voltage potential may be between 1 kV and 50 kV, or between 5 kV and 15 kV.

In some embodiments of the present disclosure, a spray system may also include the introduction of a second gas, which among other things may supply additional heat to the system and/or an additional gas flow to influence atomization and/or fluid velocities in the spraying system. Thus, in some embodiments of the present disclosure, a combining step may include mixing the atomized mixture, resulting from combining the first gas with a slurry and/or solution, with a second gas at or near the location of the first and second nozzles. A second gas may include an inert gas, oxygen, air, carbon dioxide, hydrogen, or a combination thereof. For example, the second gas may include nitrogen, helium, argon, or a combination of these. A second gas may be provided to a spray system at a temperature between 20° C. and 800° C., between 20° C. and 500° C., between 20° C. and 250° C., between 75° C. and 150° C., or between 150° C. and 220° C. Further, in some embodiments of the present disclosure, the volumetric to mass ratio of the second gas to the first mixture may be set to be between 1 L/g and 300 L/g, between 5 and 200 L/g, or between 25 and 100 L/g.

Once the targeted aggregated particles have been successfully synthesized, they may be applied directly as an aerosol to a conductive metal to form an electrode, for example, an anode for a lithium-ion battery. Aggregated particles in the first aerosol may be deposited with a second aerosol containing an additive, resulting in the forming of a second mixture. Examples of additives commonly used to make inks for battery electrodes include a dispersant, a binder, a thermally conductive additive, an ionically conductive additive, an electrically conductive additive, or combinations thereof. Exemplary binders include at least one of polyacrylic acid, lithiated polyacrylic acid, polyimide, polyethyleneimine, polyacrylamide, carboxymethyl cellulose, styrene-butadiene rubber, styrene-ethylene-butylene-styrene, polyvinylidene fluoride, NN-methylene bis(acrylamide), tetra(ethylene glycol) diacrylate, or a combination thereof. Examples of an electrically conductive additive include carbon nanotubes, carbon black, and/or graphene. In some embodiments of the present disclosure, aggregated particles may be combined with an additive to target an aggregated particles to additive mass ratio between 1 to 1, 5 to 1, between 10 to 1, between 25 to 1, or between 99 to 1.

Alternatively, once the targeted aggregated particles have been successfully synthesized, they may be used to produce an ink that may be applied to a conductive metal to form an electrode, for example, an anode for a lithium-ion battery. In some embodiments of the present disclosure, such an ink may be manufactured by combining aggregated particles with an additive in a solvent, resulting in the forming of a second mixture. Examples of a slurry solvent include water, NMP, DMAc, DMF, DMSO, DME, diglyme, triglyme, THF, other ethers, ethylene glycol, glycerin, toluene, m-cresol, ortho-chlorophenol, chloroform, pyridine, acetonitrile, supercritical carbon dioxide, or combinations thereof. Examples of additives commonly used to make inks for battery electrodes include a dispersant, a binder, a thermally conductive additive, an electrically conductive additive, or combinations thereof. Exemplary binders include at least one of polyacrylic acid, lithiated polyacrylic acid, polyimide, polyethyleneimine, polyacrylamide, carboxymethyl cellulose, styrene-butadiene rubber, styrene-ethylene-butylene-styrene, polyvinylidene fluoride, N,N-methylene bis(acrylamide), tetra(ethylene glycol) diacrylate, or a combination thereof. Examples of an electrically conductive additive include carbon nanotubes, carbon black, and/or graphene. In some embodiments of the present disclosure, aggregated particles may be combined with an additive to target an aggregated particles to additive mass ratio between 1 to 1, 5 to 1, between 10 to 1, between 25 to 1, or between 99 to 1.

With a second mixture (i.e., aerosol or ink) produced, the second mixture may be applied to a conductive metal, e.g., at least one of copper, gold, silver, molybdenum, aluminum, titanium, or a combination thereof. In some embodiments of the present disclosure, the applying a layer of a second mixture to a metal surface may be achieved by at least one of blade coating, slot die coating, Gravure coating, spray coating, or a combination thereof. In some embodiments of the present disclosure, a layer of a second mixture may be applied to a surface of a conductive metal such that the layer has a thickness between 1 and 1000 microns, between 5 and 200 microns, or between 10 and 100 microns. In some embodiments of the present disclosure, a layer of a material may serve as a buffer and/or adhesion layer between the second mixture and the conductive metal. Examples of a buffer and/or adhesion layer include carbon (amorphous, graphene, or CNTs), or molecular, polymer, or other interfacial chemical coating.

As described herein, aggregated particles may be applied to conductive metal to produce electrodes suitable for use in lithium-ion batteries. Using the manufacturing methods described herein lithium-ion battery electrodes were made that demonstrated reasonable performance metrics, given the process for making them was not optimized. Given the large number of independent variables available to a process engineer, it is completely reasonable to expect significant improvements to all of the measured performance metrics. As shown herein, an electrode made according to the methods described herein may be characterized by an areal loading between 0.8 mg/cm² and 1.25 mg/cm² or between 0.98 mg/cm² and 1.19 mg/cm². In some embodiments of the present disclosure, an electrode made according to the methods described herein may be characterized by a specific capacity of the electrode at C/10 between 1000 mAh/g and 1500 mAh/g or between 1100 mAh/g and 1390 mAh/g. In some embodiments of the present disclosure, an electrode made according to the methods described herein may be characterized by a specific capacity normalized to Si at C/10 between 1400 mAh/g Si and 1700 mAh/g Si or between 1510 mAh/g Si and 1649 mAh/g Si. In some embodiments of the present disclosure, an electrode made according to the methods described herein may be characterized by a silicon utilization at C/10 between 75% and 99% or between 83% and 90%. In some embodiments of the present disclosure, an electrode made according to the methods described herein may be characterized by a 6 C capacity retention relative to C/10 between 30% and 70% or between 51% and 61%.

As described above, the methods described herein result in the formation of a composition that includes a plurality of aggregated particles. These aggregated particles include silicon nanoparticles embedded within a matrix, which may be a porous and/or carbonaceous matrix. In some embodiments of the present disclosure, aggregated particles may have a maximum average length between 0.1 μm and 50 μm, between 0.1 μm and 25 μm, or between 1.0 μm and 10 μm, with embedded silicon nanoparticles having an average particle size between 1 nm and 100 nm, or between 5 nm and 50 nm, or between 5 nm and 30 nm, or between 10 nm and 15 nm.

As shown herein, a notable feature of the composition is the morphology of the aggregated particles. In some embodiments of the present disclosure, a first portion of aggregated particles may be characterized by a structure that includes a continuous peripheral body defining a central recess. This structure may impart a cup-like or bowl-like appearance to the aggregated particles. In some embodiments of the present disclosure, the continuous peripheral body of these aggregated particles may have an irregular or oblong profile. In some embodiments of the present disclosure, aggregated particles having this central recess may have an average maximum outer dimension between 0.1 μm and 25 μm, between 0.1 μm and 10 μm, or between 0.5 μm and 1.5 μm, with the central recess itself having a maximum outer dimension, for example, between 0.5 μm and 10 μm, between 0.1 μm and 2.0 μm, or between 0.1 μm and 0.5 μm. In some embodiments of the present disclosure, a central recess may extend entirely through the continuous peripheral body, thereby forming a central aperture. This first portion of aggregated particles may be characterized as having morphologies that include an indented sphere, a dimpled sphere, a buckled sphere, a toroidal shape, or combinations of these shapes.

In some embodiments of the present disclosure, aggregated particles may include other particle populations. For example, aggregated particles may also include a second portion of particles that are substantially spherical primary particles. In some embodiments of the present disclosure, this second portion may have an average diameter, for example, between 30 nm and 150 nm. In some embodiments of the present disclosure, a fraction of these smaller, spherical primary particles may be physically connected to the first portion of particles having a central recess.

As previously described, in some embodiments of the present disclosure, aggregated particles may be porous. For example, aggregated particles may have an average porosity 0 vol % and 80 vol %, between greater than 0 vol % and 80 vol %, between 5 vol % and 75 vol %, or between 10 vol % and 50 vol %. Further, the porosity of aggregated particles may be characterized by the pore sizes and/or pore distributions. In some embodiments of the present disclosure, aggregated particles may include macropores, mesopores, micropores, or a combination thereof. In some embodiments of the present disclosure, the macropores may have pores with a diameter between 50 nm and 1000 nm. In some embodiments of the present disclosure, the mesopores may have pores with a diameter between 2 nm and 50 nm. In some embodiments of the present disclosure, the micropores may have pores with a diameter less than 2 nm.

Early experiments testing the methods described above focused on two embodiments for increasing the porosity of silicon nanoparticles (NPs) and/or for synthesizing silicon nanoparticle and carbonaceous composites, i.e., aggregated particles. The first method was based on spray drying, for example electrostatic spray drying, in the absence of any significant chemical reactions. The second method was based solely on chemistry. However, as described above, the chemical reactions may be completed during a drying step to produce aggregated particles.

Regarding the first method, spray drying aerosolizes small droplets of solid-liquid mixtures (solutions, colloids, dispersions, etc.) in a chamber. The liquid evaporates from aerosol droplets within the chamber and is removed via gas flow and/or dynamic pumping, while the remaining solid is collected as the product. The spray drying conditions (gas flow rate, chamber pressure, chamber temperature, etc.) impact many of the properties of the solid product. The solid product properties are also impacted by the aerosol droplet size and other factors. For instance, electrostatic spray drying may utilize microencapsulation in which a solvent is more polarizable and, therefore, has a larger electric dipole moment compared to the silicon nanoparticles. Consequently, electrostatically charged solvent molecules repel both each other and solid particles, which forces the solvent and carrier to migrate to the outer surface of the droplet, while the solid particles remain at the center. Driving the solvent to the outer surface creates excellent drying conditions, can lead to excellent encapsulation of the solid particles without the use of high evaporation temperatures and resulting in secondary (abbreviated as “2°”) particles, i.e. aggregated particles, forming having average diameters between 500 nm and 25 μm.

The solvent used in initial spray drying tests was N-methyl-2-pyrrolidone (NMP). In a manufacturing scenario, the solvent may be recovered and recycled to the front end of the spray drying process. The silicon nanoparticles used in these initial feasibility studies were synthesized in a plasma-enhanced chemical vapor deposition (PECVD) process. Silicon particles made in this fashion are referred to herein as PECVD silicon nanoparticles. Silicon nanoparticles may have a size (i.e., diameter) between 3 nm and 300 nm or between 3 nm and 30 nm once removed from the PECVD reactor prior to any surface functionalization or agglomeration.

A variety of process parameters may be adjusted to tune the morphology and size of aggregated particles. These include: (1) fluid solid concentrations in a solution, colloid, and/or dispersion, e.g., between 1 wt % and 50 wt % solids content; (2) fluid flow rate; (3) drying gas flow rate; (4) drying gas temperature, e.g., between 5° C. and 250° C.; (5) nozzle properties (orifice size, spray angle, etc.) and (5) spray method (thermal, electrostatic, etc.). As previously described, in some embodiments of the present disclosure, a slurry containing silicon nanoparticles and solvent may also include at least one of a conductive carbon and/or a binder. Examples of conductive carbons include at least one of a carbon black (CB), a carbon nanorod (CNR), and/or a carbon nanotube (CNT). In some embodiments of the present disclosure, blending CNTs and/or polymer binder with PECVD silicon nanoparticles during the spray drying process may be a way to generate porosity within the aggregated particles and enable more rapid Li-ion transport during charge/discharge. Aggregated particles obtained from a spray drying process may be blended into conventional slurries and printed by doctor blade, followed by electrode drying and curing. Electrochemical analysis may be performed to determine the effect of enhanced porosity on capacity, rate dependence, and cycle and calendar life performance of anodes constructed using the materials produced in the spray drying systems described herein.

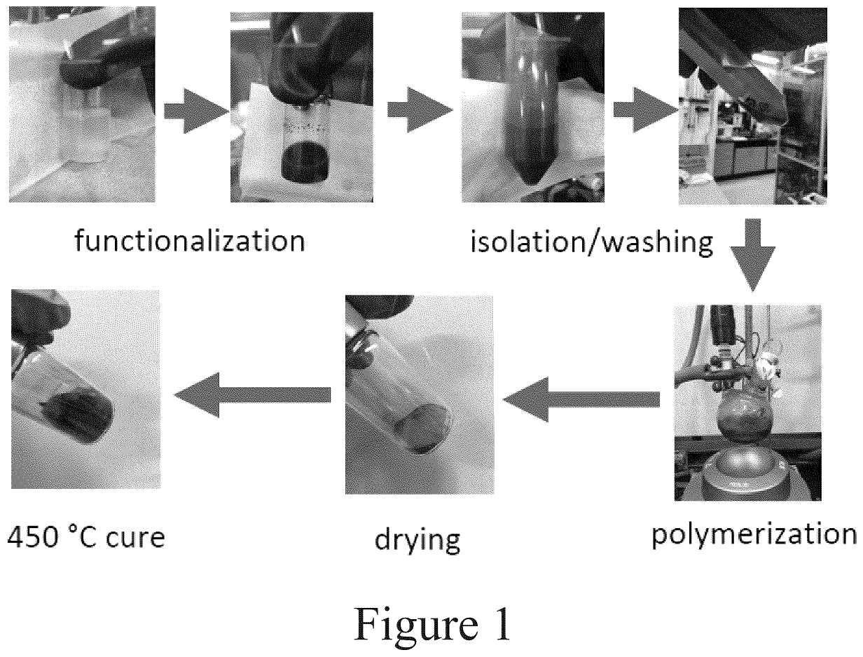

The second method tested in the initial feasibility studies increased the porosity of silicon nanoparticles and/or silicon-carbon composites by utilizing cross-linking polymerization. FIG. 1 illustrates the multi-step method tested in these initial studies for obtaining silicon and/or silicon-carbon composite materials having increased porosity, by polymerization, without spray drying. As illustrated, this method included a functionalization step, an isolation/washing step, a polymerization step, a drying step, and a curing step. These steps were performed in series, which are described below. These concepts are explained further in the inventors' publication (Adv. Energy Mater. 2023, 2203921), which is incorporated herein by reference in the entirety.

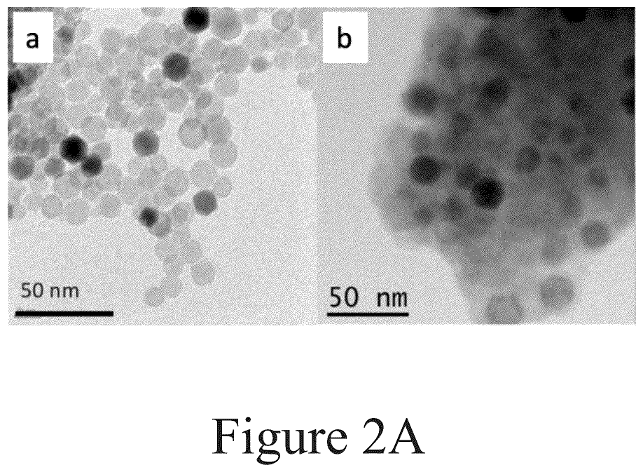

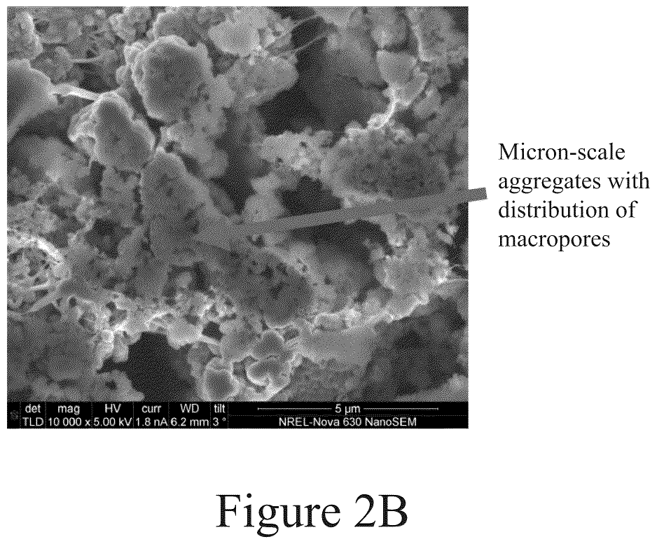

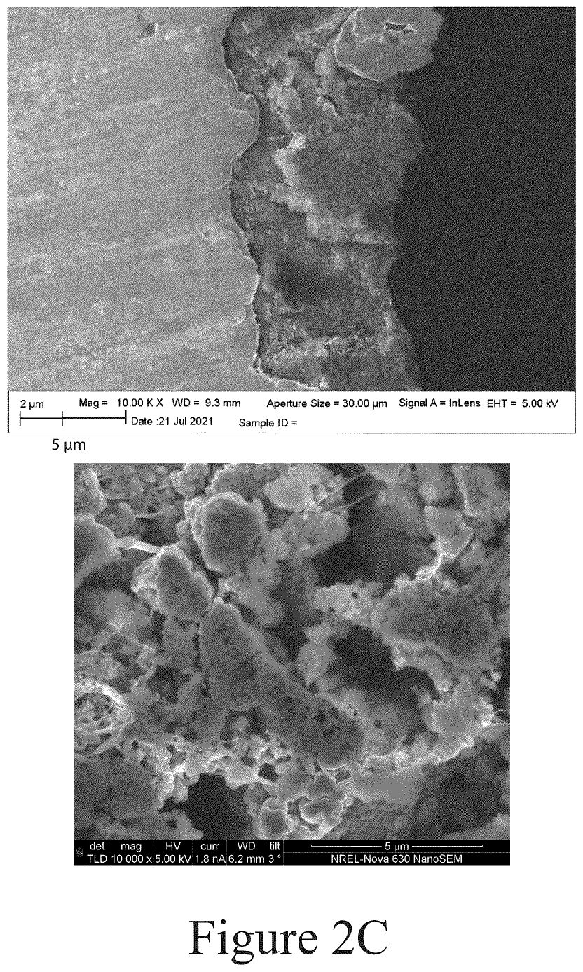

First, 30 nm diameter silicon nanoparticles were functionalized with terephthalaldehyde using a 1,1′-azobis(cyclohexanecarbonitrile) radical initiator in diglyme at 150° C. for 24 hours. Next, the nanoparticles were washed twice with anhydrous toluene and isolated via centrifuge at 12,500×g for 5 minutes. Next, the polymerization was completed using a two-step process where, first, an imine polymer precursor was formed by reacting phenylenediamine with hexylaldehyde in diglyme at 100° C. for 60 minutes with dry nitrogen sparging to form 1,4-phenyldihexylimine (PDHI) via a condensation reaction. The resultant PDHI particles were then combined with terephthalaldehyde (TPA) and PDHI in diglyme to form a polyPMI coating via an imine metathesis reaction at 175° C. for 120 minutes in diglyme, while evaporating the diglyme solvent to dry and isolate the aggregated particles. This reaction coated the PECVD silicon nanoparticles with polyPMI and crosslinked the particles to form aggregated particles as the polymerization progressed. Finally, the dried and isolated particles were cured in a tube furnace at 450° C. under a continuous dry nitrogen purge for 4 hours. FIG. 2A illustrates transmission electron microscopy (TEM) image of the silicon particles before and after applying the aggregation method. The image illustrates that the cross-linking polymerization method effectively agglomerated silicon nanoparticles having a starting particle size of about 30 nm into agglomerates. FIG. 2B illustrates a SEM cross-sectional image of electrodes made from these aggregates and having an average particle size between 500 nm and 5 μm and a total porosity between about 10 vol % and 50 vol %. FIG. 2C illustrates SEM cross-sectional images comparing electrodes made from silicon nanoparticles having no cross-linking (no aggregated particle formation—top panel) with silicon nanoparticles with cross-linking (after the formation of aggregated particles—bottom panel), according to some embodiments of the present disclosure. Both images are at 10,000× magnification.

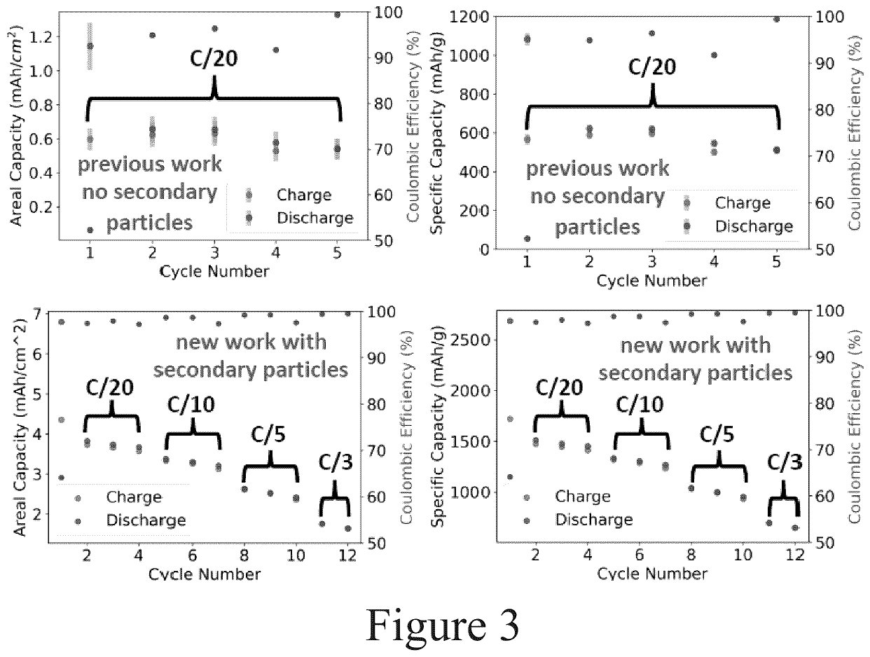

FIG. 3 illustrates a comparison of cell performance data obtained from a half-cell using the aggregated particles synthesized using the method illustrated in FIG. 1. The electrodes were tested using 2032 coin cells in a half-cell configuration. Each electrode comprised a 14 mm-diameter circular punch on copper foil. The half-cells were assembled in a glovebox with the 14 mm silicon electrodes as the positive electrode. The negative electrodes used were 9/16 inch diameter circular punches of Li metal foil (Alfa Aesar 10 769, 0.75 mm thick, 99.9% metals basis) that were cleaned with a toothbrush before being pressed onto a 15 mm-diameter, 1 mm-thick stainless-steel spacer with a stainless-steel wave spring positioned on the opposite side. The electrodes were separated by a 19 mm circular punch of porous polypropylene separator (Celgard 2325). Each cell was injected with 20 μL of the Gen2F electrolyte (LiPF₆ in ethylene-carbonate/ethyl-methyl-carbonate in a 3:7 by mass ratio with 3 wt % of fluoroethylene carbonate added) onto each side of the separator (40 μL total) before the cells were sealed by a hydraulic crimper. Each cell was allowed to rest at open circuit potential for 4 hours before being galvanostatically cycled between 0.01 and 1.5 V versus Li at various rates to test the rate capability of the porous electrodes (C/20, C/10, C/5, and C/3, where the cells were cycled at varying current densities to achieve cycling in 20, 10, 5, and 3 hours respectively. These data show a clear benefit of aggregate particle formation to the electrode specific capacity (600 mAh/g with no aggregate particles cf.~1400 mAh/g with aggregates), areal capacity (0.6 mAh/cm² with no aggregate particles cf.~3.5 mAh/cm² with aggregates) and reasonable rate initial capability with electrodes containing aggregate particles. Although promising, these data illustrated clear room for improvement, so additional studies were completed, as described below.

Dense PECVD silicon nanoparticle anodes were prepared with a different formulation using polyimide as a binder and carbonaceous material precursor, as described in the inventors' publication (J. Mater. Chem. A 2023, 11, 5257), which is incorporated herein by reference in the entirety. This dense electrode was compared to those made from compositionally similar particle aggregates via two different processing methodologies. An objective was to maintain the benefits of the original approaches, the encapsulation of PECVD-synthesized silicon nanoparticles in a aggregated carbonaceous matrix that is both mechanically and electrochemically robust, while intentionally building aggregated particles that should generate a porous electrode that facilitates Li-ion transport, even as electrode thickness increases. The first approach to generating such aggregated particles was by thermally curing the molecularly coated PECVD silicon nanoparticles with a polymer carbonaceous matrix precursor followed by ball milling the annealed material. The second approach leveraged electrostatic spray drying (ESD) of the same PECVD silicon nanoparticles/polymer mixture that, as shown herein, can generate aggregated particles having toroidal structures ranging from 0.1 μm to 1 μm in diameter that are preserved following annealing.

As shown herein, the unique toroidal morphology of the aggregated particles produced by ESD resulted in the synthesis of thin electrodes (0.98 to 1.19 mg/cm² areal loading) having comparable to improved performance metrics relative to the electrodes produced from other processing methodologies to make other silicon-containing materials. Specifically, silicon anodes containing the toroidal morphology exhibited comparable silicon utilization as well as enhanced rate capability compared to ball milled silicon or non-aggregated silicon anodes, showing a clear pathway to achieving the higher areal loadings necessary to achieve industrially relevant energy densities in a full cell. More broadly, these results highlight the potential advantages of electrospray drying in tailoring active material morphologies for next-generation battery applications that could be applied to a range of different active materials.

PECVD Si Anode Active Material (AAM) & Electrode Fabrication. Polyethylene oxide-coated Si (Si@PEO₂) NPs were prepared from a PECVD process using silane gas as reported previously. The Si@PEO₂ NPs form a colloid in a variety of solvents and were used directly in a slurry and cast into a dense electrode or processed into aggregated AAMs.

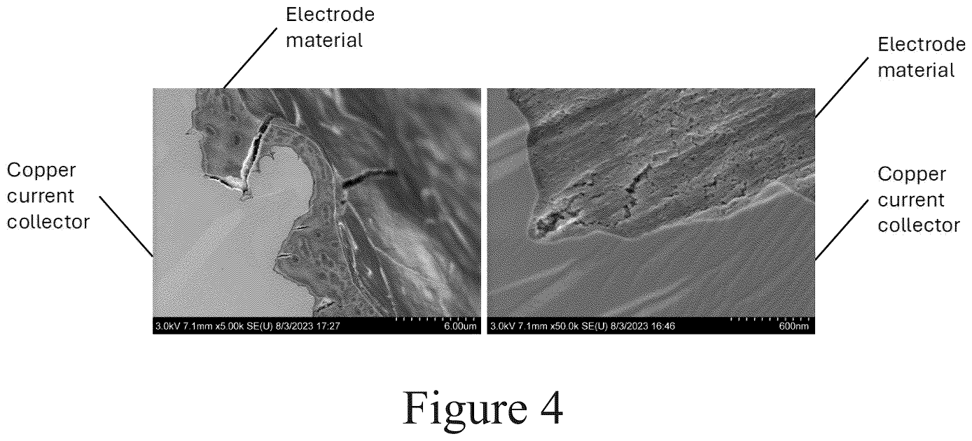

Briefly, Si@PEO₂ NPs were dissolved in N-methyl-pyrrolidone (NMP) solvent and mixed with polyimide (PI) binder and carbon nanotubes (CNTs) and cast directly onto a Cu current collector to form the raw anode, which was subsequently annealed under inert gas at 420° C. to liberate the PEO molecular coating and thermally cure the PI binder. Due to the nanoscale size of the PECVD Si@PEO₂ AAM, it packs into a dense solid upon drying and thermally curing electrodes, termed Non-Aggregated PECVD Si Electrodes, that are approx. 10% porous prior to cycling as illustrated in FIG. 4.

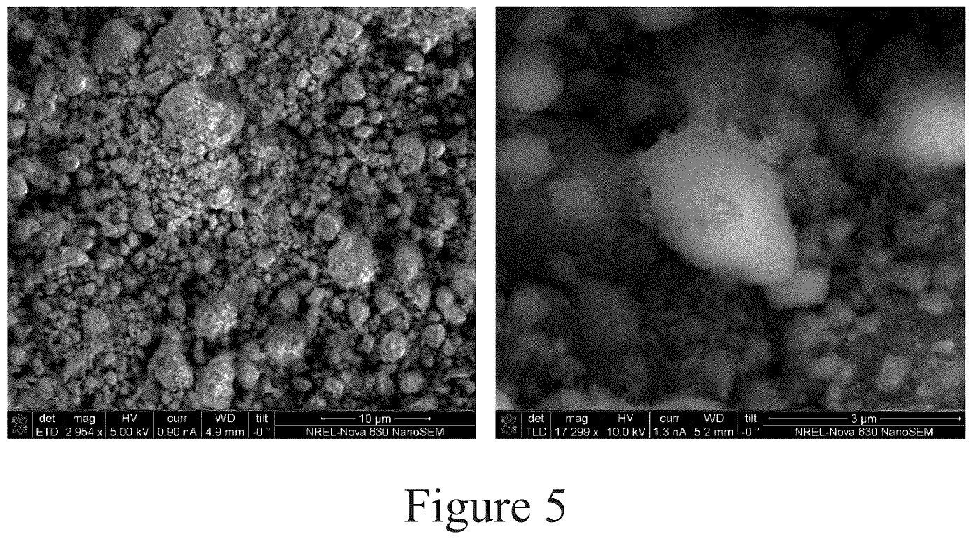

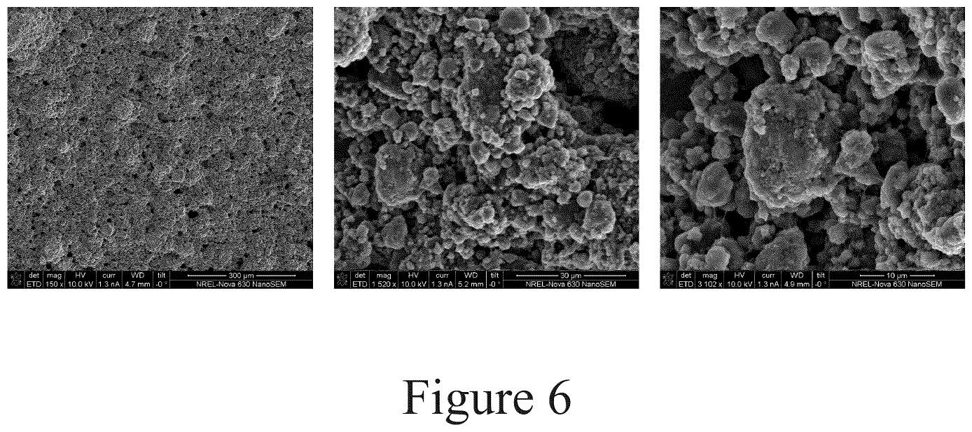

Ball Milled Si AAM were formed by dissolving Si@PEO₂ NPs and polymer in N,N-dimethylacetamide (DMAc), which was chosen due to its 6-fold higher vapor pressure at ambient temperature cf. NMP that aids drying. In some embodiments of the present disclosure, Ball Milled Si AAM were formed by dissolving Si@PEO₂ NPs with polyimide (PI) binder and a carbon nanotube (CNT) dispersion containing PVDF dispersant. Ball Milled PECVD Si AAM was formed by simply drying the solution in vacuo, thermally curing the resulting Si@PEO₂/PI or Si@PEO₂/PI/CNT/PVDF mixed solid, and ball milling. This generated Ball Milled PECVD Si AAM with a wide particle size distribution with dimensions on the order of 10 microns as illustrated in FIG. 5 (Si/PI/CNT/PVDF) and FIG. 6 (Si/PI).

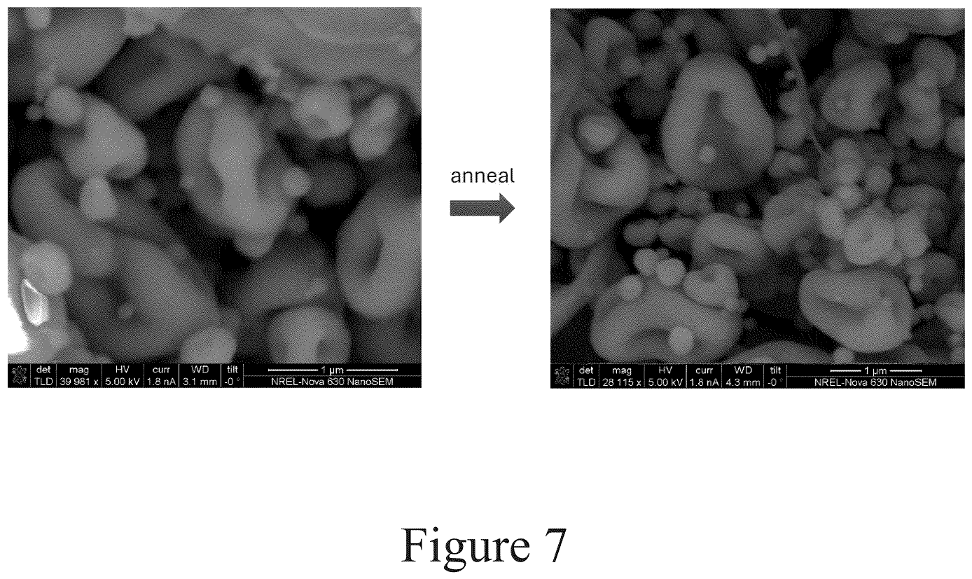

ESD PECVD Si AAM was made similarly to Ball Milled PECVD Si AAM except drying was accomplished using a commercial electrostatic spray dryer followed by thermal curing of the ESD-derived aggregated particles. As previously described, ESD may be faster and lower energy than conventional thermal spray drying because aerosolized droplets are electrostatically charged. The high electrostatic charge on each droplet causes polar solvent molecules to be forced to the droplet surface that speeds drying. Consequently, lower temperature and/or faster drying rate is achieved compared with non-electrostatic spray drying. NMP was used initially as the solvent, however, it was determined that the drying rate was insufficient. Switching to the 6-fold higher vapor-pressure DMAc resulted in a toroidal aggregated morphology that is indicative of fast drying (see left Panel of FIG. 7). In some embodiments of the present disclosure, PI polymer was used. In some embodiments of the present disclosure, polyacrylonitrile (PAN) polymer was used. The PI polymer is reported to be very thermally robust, which is confirmed by retention of the toroid morphology following annealing at 420° C. for 4 hours (see right Panel of FIG. 7). The PAN polymer is known to undergo thermal cyclization to form cyclopolyacrylonitrile (cPAN) that also is expected to retain the AAM aggregate morphology.

Both Ball Milled and ESD PECVD Si Electrodes were made by blending the respective AAM with polyacrylic acid (PAA) binder in NMP and casting electrodes. The results indicated that a high PAA content (14 wt %) was desirable for ESD PECVD Si Electrodes that mitigated delamination that was observed with ESD material and 10 wt % PAA, presumably due to its large surface area based on SEM images. Ball Milled Si Electrodes were prepared with the same 14 wt % PAA content to provide a direct comparison between these two methods. No electrode-level annealing was necessary on either electrode since both AAMs already had been thermally cured. However, it is worthwhile pointing out that even standard electrode drying conditions (120-150° C. under vacuum) can result in cross-linking of the PAA.

FIG. 4 illustrates SEM cross-sectional images of non-aggregated PECVD Si electrode prior to electrochemical cycling showing its dense structure containing mesopores, according to some embodiments of the present disclosure. This anode was printed on a roughened copper substrate, according to some embodiments of the present disclosure. Dense anodes exhibit macroscopic cracks from film densification during drying (i.e., mud cracking) and in the bulk electrode feature limited porosity characterized by mesopores (<50 nm diameter) in the bulk electrode material between the macroscopic mud cracks.

FIG. 5 illustrates SEM images of ball milled aggregated particles showing its morphology following annealing, according to some embodiments of the present disclosure. PECVD Si AAM composition was 85:15 Si/polyimide (wt %). Ball milled aggregated Si AAM features a heterogeneous particle size ranging from ca. 10 to <1 microns in diameter and a heterogeneous particle morphology with oblong, quasi-spherical, and other geometric shapes (e.g., trapezoid, rhomboid) evident.

FIG. 6 illustrates SEM images of ball milled aggregated particles once processed into an electrode showing macroscopic pores, according to some embodiments of the present disclosure. Electrode composition is PECVD Si AAM (Si/PI):PAA:CNTs:PVDF 83:14:1:2 (wt %), which was 71 wt % Si. These images show the presence of a relatively uniform film morphology with macroscopic pores from several to approx. 10 microns dispersed throughout the film as well as substantial interstitial space between aggregated particles.

FIG. 7 illustrates SEM images of spray dried aggregated particles showing toroidal morphology that is retained following annealing, according to some embodiments of the present disclosure. This is a 4-component mixture of PECVD silicon nanoparticles at the following component ratios: Si:polyimide:CNTs:PVDF 85:12:1:2 (wt %). These ESD aggregated Si AAM features a heterogeneous particle size ranging from ca. 1 to 0.1 microns in diameter and a heterogeneous particle morphology with a cup-like or bowl-like structure evident for all but the smallest particles.

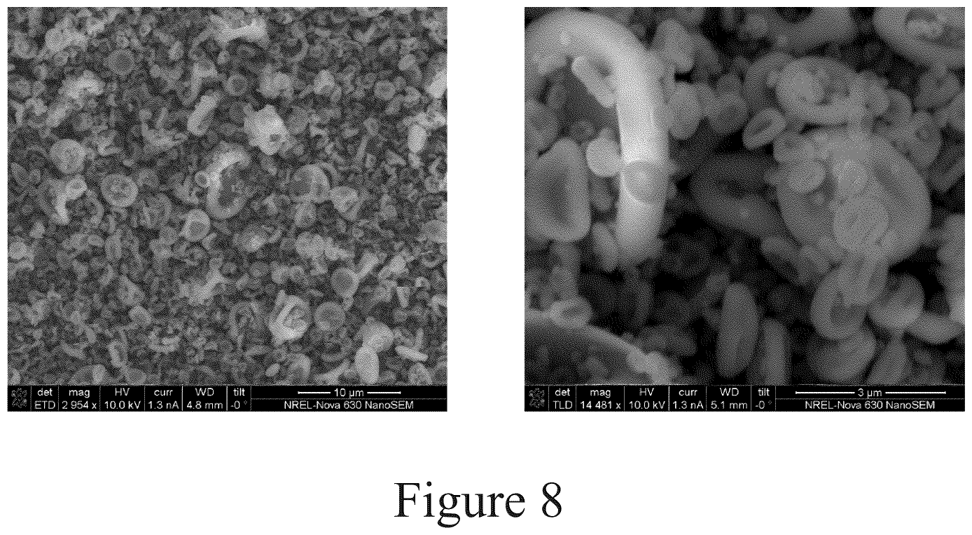

FIG. 8 illustrates SEM images of spray dried aggregated particles showing toroidal morphology at two different magnifications, according to some embodiments of the present disclosure. This was a two-component mixture of PECVD Si Si:polyimide 85:15 (wt %) that has been annealed. These ESD aggregated Si AAM features a heterogeneous particle size ranging from ca. 5 to 0.1 microns in diameter and a heterogeneous particle morphology with a cup-like or bowl-like structure evident for all but the smallest particles.

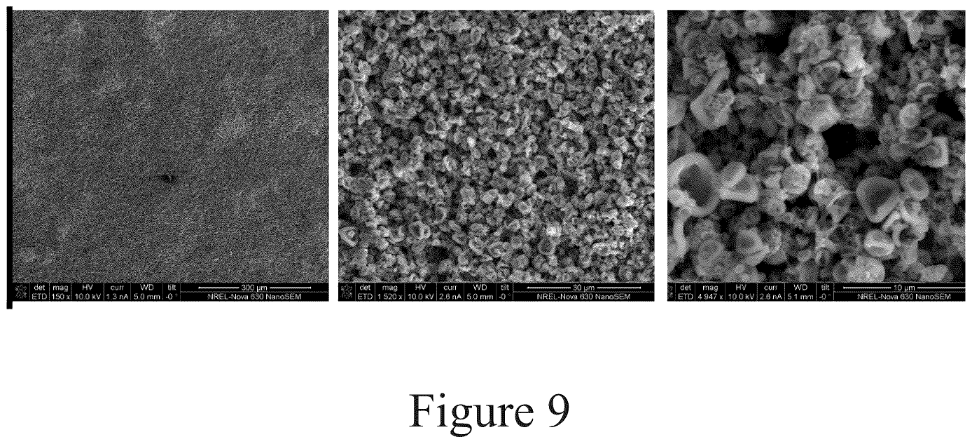

FIG. 9 illustrates SEM images of spray dried aggregated particles once processed into an electrode showing macroscopic pores, according to some embodiments of the present disclosure. Electrode composition was PECVD Si AAM (Si/PI):PAA:CNTs:PVDF 83:14:1:2 (wt %), which is 71 wt % Si. These images show the presence of a relatively uniform film morphology with macroscopic pores from approx. 1-5 microns dispersed throughout the film as well as substantial interstitial space between aggregated particles.

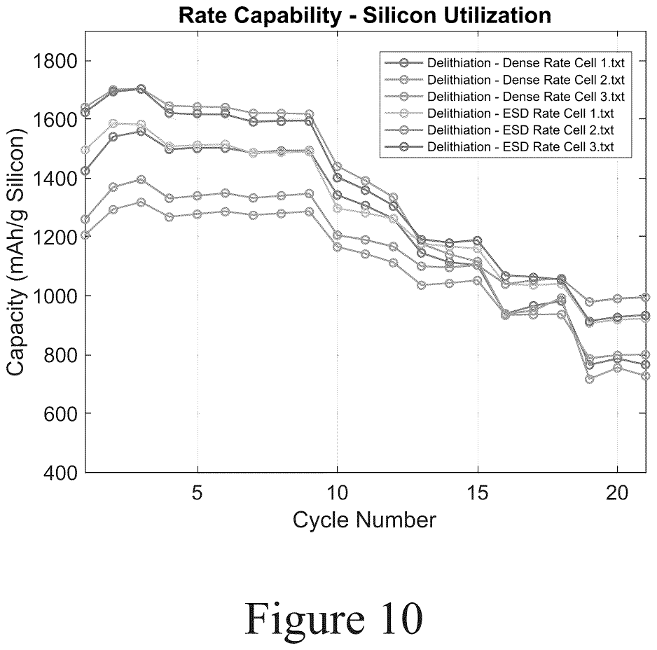

FIG. 10 illustrates symmetric rate capability test comparing normalized capacity of ESD electrode with a polyacrylic-acid-based binder versus non-aggregated Dense electrode at various C-rates, according to some embodiments of the present disclosure. These data demonstrate that the capacity retention for the fastest charge/discharge rates (4 C, 6 C) was better for electrodes using aggregated particles synthesized by electrostatic spray drying (described above) than that for dense electrodes (described above). Given the capacity retention differences are observed at these low loading electrodes, we would anticipate that even greater rate performance is found for ESD vs. Dense electrodes at higher loadings.

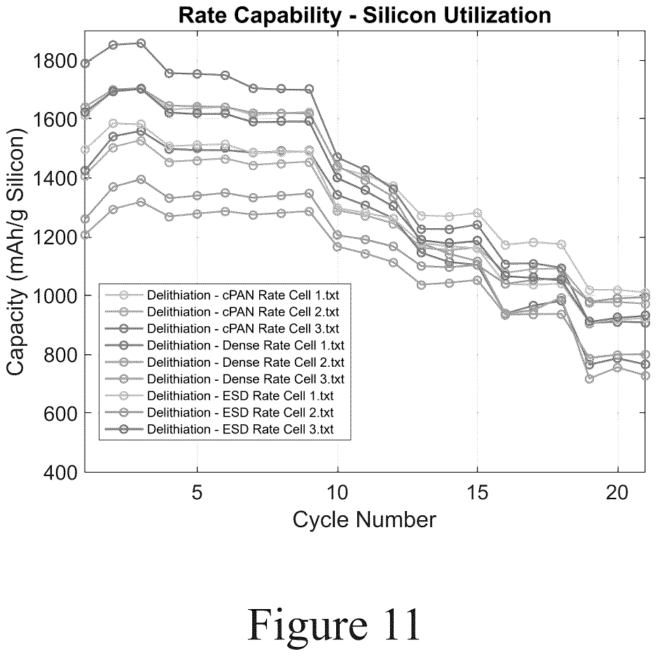

FIG. 11 illustrates symmetric rate capability test comparing normalized capacity of two different types of ESD electrode (‘ESD’ is from Si/PI AAM aggregate; ‘cPAN’ is from Si/cPAN AAM aggregate) with a polyacrylic-acid-based binder versus non-aggregated Dense electrode at various C-rates, according to some embodiments of the present disclosure. As in FIG. 10, these data demonstrate that the capacity retention for the fastest charge/discharge rates (4 C, 6 C) was better for electrodes using aggregated particles synthesized by electrostatic spray drying (described above) than that for the dense electrodes (described above). Given the capacity retention differences are observed at these low loading electrodes, we would anticipate that even greater rate performance is found for ESD vs. Dense electrodes at higher loadings.

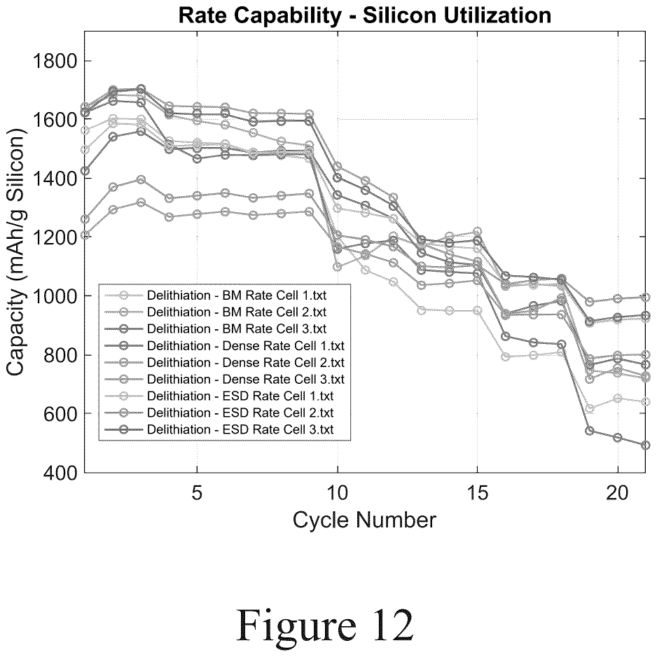

FIG. 12 illustrates rate capability of electrodes made from non-aggregated (Dense), ball milled (BM), and ESD PECVD Si AAM, according to some embodiments of the present disclosure. As in FIGS. 10 and 11, these data demonstrate that the capacity retention for the fastest charge/discharge rates (4 C, 6 C) was better for electrodes using aggregated particles synthesized by electrostatic spray drying than Dense or BM electrodes. Given the capacity retention differences are observed at these low loading electrodes, we would anticipate that even greater rate performance is found for ESD vs. Dense/Ball Milled electrodes at higher loadings. Despite the BM electrodes exhibiting a higher average normalized specific capacity (1649 mAh/g Si) at C/10 than ESD electrodes (1549 mAh/g Si) at an identical composition, its rate capability was worse than electrodes fabricated using aggregated particles made via the ESD method. The averages from the data illustrated in FIGS. 10 through 12 are summarized in Table 1 below.

TABLE 1
Summary Table for ESD, Ball Milled, and
Non-Aggregated PECVD Si AAM Electrodes

| | | Specific | Specific | | 6C |
|---|---|---|---|---|---|
| Electrode | | Capacity | Capacity | | Capacity |
| Label | Areal | (mAh/g | (mAh/g Si) at | Silicon | Retention |
| and Composition | Loading | electrode) | C/10 - i.e., | Utilization | Relative |
| (mass %) | (mg/cm2) | at C/10 | normalized to Si | at C/10 | to C/10 |
| Non- | 0.98 | 1390 | 1510 | 83% | 51% |
| Aggregated | | | | | |
| Si/PI/CNT/PVDF | | | | | |
| (92:5:1:2) | | | | | |
| Ball Milled | 1.19 | 1171 | 1649 | 90% | 38% |
| Si/PI/PAA/ | | | | | |
| CNT/PVDF | | | | | |
| (71:12:14:1:2) | | | | | |
| ESD | 1.07 | 1100 | 1549 | 85% | 61% |
| Si/PI/PAA/ | | | | | |
| CNT/PVDF | | | | | |
| (71:12:14:1:2) | | | | | |
| ESD | 1.01 | 1194 | 1682 | 92% | 58% |
| Si/cPAN/PAA/ | | | | | |
| CNT/PVDF | | | | | |
| (71:12:14:1:2) | | | | | |

### Experimental

All air-free reactions and manipulations were performed using standard Schlenk-line techniques or in an inert-atmosphere glovebox under N₂ or Ar atmospheres, respectively.

Anhydrous solvents N-methyl-pyrrolidone (NMP) and N,N-dimethylacetamide (DMAc), polyacrylonitrile (PAN), and polyacrylic acid binder (450 k) were purchased from Sigma-Aldrich and used as received. Polyimide (PI) polymer was purchased from Ensinger (Tecapowder P84, granulat STD/SG) and used as received. Carbon nanotube (CNT) dispersion was purchased from Tuball (BATT NMP, 1 wt % CNTs with 2 wt % PVDF dispersant) and used as received.

Plasma-Enhanced Chemical Vapor Deposition Silicon Anode Active Material (PECVD Si AAM) Preparation. Three different types of PECVD Si AAM were investigated and prepared as follows.

Non-Aggregated PECVD Si AAM. Polyethylene oxide-coated silicon nanoparticles (Si@PEO₂ NPs) were prepared from 5.9-nm diameter intrinsic, hydrogen-terminated silicon nanoparticles that were grown from a PECVD process using silane gas as reported previously. The Si@PEO₂ NPs form a colloid in NMP solvent that was used directly in a slurry or processed further into aggregated particles.

BallMilledPECVD Si AAM Si@PEO₂ NPs and PI binder were suspended in DMAc in a mass ratio of 85:15 (w/w) to make a 5 wt % solids loading solution. DMAc solvent was removed via vacuum transfer, and the dried solid was annealed under flowing inert nitrogen gas at 420° C. for 4 h using a rapid ramp rate (15 min) to 420° C. followed by slow cooling over ~10 h. Annealing caused ~25 wt % mass loss, as expected from liberation of the polyethylene oxide (PEO) molecular coating on the PECVD Silicon nanoparticles at this temperature. The annealed material (~2.5 g) was subsequently ball milled under inert gas in a 45-mL hermetically sealed zirconia milling jar (Fritsch) at 500 rpm for 5 min using a Fritsch Pulverisette 7. Milling was first performed with 8×5-mm zirconia grinding balls that were then mechanically removed. A second milling step was performed using ~10-mL of 3-mm zirconia grinding balls. The ball milled powder was then passed through a 325-mesh sieve in a glovebox to yield a dark brown-black powder with a tap density of ~0.5 g/cm³ and was stored under inert gas until processing into an electrode.

Electrostatic Spray Drying (ESD) PECVD Si AAM A 5 wt % solids 85:15 (w/w) Si@PEO₂:PI or Si@PEO₂:PAN in DMAc solution (identical to that used to prepare ball milled material) was prepared for ESD. ESD was performed using a PolarDry Model 0.1 system supplied by Fluid Air Inc., a division of Spraying Systems Co., using a 0.016″/0.064″ electrostatic spray nozzle at 5 kV, inert nitrogen gas flow of 7.0 Nm³/h, inlet drying gas temperature of 140° C., atomizing gas pressure of 200 kPa, and fluid introduction rate of 1.8±0.1 g/min. Aggregated particles produced from ESD were collected from the ESD process on a 0.3-micron filter sock. Following system cooling to <60° C., the ESD material was collected as a light brown powder in air ambient. The light brown powder was annealed under flowing inert nitrogen gas at 420° C. for 4 h using a rapid ramp rate (15 min) to 420° C. followed by slow cooling over ~10 h. Annealing caused ~25 wt % mass loss, as expected from liberation of the polyethylene oxide (PEO) molecular coating on the PECVD Silicon nanoparticles at this temperature. ESD material was slightly darker brown following annealing and stored under inert gas until processing into an electrode.

### Slurry & Electrode Preparation.

Dense Electrode from Non-Aggregated PECVD Si AAM. Si@PEO₂ NP powder (1.6 g) was suspended in N-methyl-pyrrolidone (NMP, 6.4 g) in a 20-mL scintillation vial with stirring in a glovebox for several hours. The CNT slurry (1.27 g) was added, and the mixture was stirred for ~12 h. A 10 wt % PI solution in NMP (0.63 g) was added and briefly stirred, then removed from the glovebox for mixing and printing.

Electrodes from Ball Milled and ESD PECVD Si AAM Ball milled or ESD PECVD Si AAM was mixed with NMP solvent, PAA binder, and CNT dispersion at a solids loading of 17 wt % (ball milled) or 17 wt % (ESD) and then mixed and cast as described below. Ball milled electrodes contained a mass ratio of 74:13:10:1:2 PECVD Si:PI:PAA:CNT:PVDF, assuming no PI mass loss during annealing. ESD electrodes contained a mass ratio of 71:12:14:1:2 PECVD Si:PI:PAA:CNT:PVDF, assuming no PI mass loss during annealing.

Slurry Casting and Electrode Processing. All slurries were mixed using a Mazerustar Kurabo KK-250S dual axis mixer 90 s (rotation rate of 1400 rpm, revolution rate 400 rpm). The slurry was then blade cast onto a Cu current collector in air using a ZAA 2300 Zehntner automatic film applicator coater at 1 cm/s using a fixed blade with either 100- or 200-micron gap. Wet films were dried in a vacuum oven at 150° C. for 4 h under roughing pump vacuum (~10⁻² Torr).

After casting, dried Dense Electrodes from Non-Aggregated PECVD Si AAM were annealed under flowing inert nitrogen gas at 420° C. for 4 h using a rapid ramp rate (15 min) to 420° C. followed by slow cooling over ~10 h. Electrodes from Ball Milled Material or ESD Material did not require annealing to remove the polyethylene oxide molecular coating as these PECVD Si AAM materials had been annealed prior to electrode casting.

All electrodes were stored under inert gas and dried at 120° C. for 1 h under roughing pump vacuum (~10⁻² Torr) prior to fabrication into coin cells.

Coin Cell Fabrication. Half-cell measurements were performed against Li-metal in a 2032 coin-type configuration using stainless steel components. Coin cells were fabricated using a 15 mm diameter circular punch of the Si-based composite anode and constructed by placing, in order: a can, washer, electrode sample, 20 μL electrolyte, d=19 mm diameter Celgard separator (2325), 20 μL electrolyte, d= 9/16″ lithium metal (with the surface oxide layer scraped off), gasket, washer, wave spring, cup and pressing the assembly in a coin cell press. The electrolyte used for these experiments was GenF3: 3:7 w/w ethylene carbonate:ethylmethylcarbonate with 1.2 M LiPF₆+3 wt % fluoroethylene carbonate (FEC) supplied by Tomiyama. The cell was sealed using a Hohsen automatic hydraulic crimper and rested at open circuit for ~2 h prior to electrochemical analysis.

Electrochemical Cycling. All electrochemical cycling was performed on a Maccor Series 4000 cycler. The cycling protocol consisted of three lithiation/delithiation forming cycles between 0.05 and 0.65 V vs Li/Li⁺ at a rate of C/10. C-rates were calculated based on the assumed experimental silicon capacity of 3579 mAh g⁻¹ and measured capacity of 120 mAh g⁻¹.

### Scanning Electron Microscopy (SEM) Characterization.

SEM imaging was performed with a Hitachi 4800 microscope operating at 15 kV accelerating voltage with a working distance of approximately 10-12 mm. Samples for cross-sectional SEM images were prepared by tearing an electrode (either before or after electrochemical cycling). Plan-view images were collected with no further sample preparation steps.

### EXAMPLES

Example 1. A method comprising: combining silicon nanoparticles and a precursor to form a first mixture, wherein: the combining results in the forming of aggregated particles comprising the silicon nanoparticles embedded in a matrix derived from the precursor.

Example 2. The method of Example 1, wherein the combining results in a porous matrix.

Example 3. The method of either Example 1 and/or Example 2, wherein the combining is performed by a mechanical means.

Example 4. The method of any one of Examples 1-3, wherein the mechanical means is selected from the group consisting of ball-milling, jet milling, stirred media milling, immersion milling, cryo-milling, ultrasonic milling, or a combination thereof.

Example 5. The method of any one of Examples 1-4, further comprising, during the combining and/or after the combining, heating the silicon nanoparticles and the precursor to a temperature between 20° C. and 800° C., between 20° C. and 500° C., between 300° C. and 500° C., between 80° C. and 300° C., or between 20° C. and 250° C.

Example 6. The method of any one of Examples 1-5, wherein: the first mixture further includes a solvent and the combining results in the forming of at least one of a slurry, a solution, or a combination thereof, prior to the forming of the aggregated particles.

Example 7. The method of any one of Examples 1-6, wherein the first mixture further comprises a first additive comprising at least one of a dispersant, a binder, a thermally conductive additive, an ionically conductive additive, an electrically conductive additive, or a combination thereof.

Example 8. The method of any one of Examples 1-7, wherein the first additive comprises at least one of a carbon nanotube, carbon black, graphene, another conductive carbon material, or a combination thereof.

Example 9. The method of any one of Examples 1-8, wherein the combining further comprises directing the first mixture through a first nozzle.

Example 10. The method of any one of Examples 1-9, wherein the directing of the first mixture through the first nozzle creates a spray.

Example 11. The method of any one of Examples 1-10, wherein the directing of the first mixture through the first nozzle results in a pressure drop between 100 kPa and 2,000 kPa, between 1,000 kPa and 1,700 kPa, between 400 kPa and 1,000 kPa, or between 140 kPa and 400 kPa.

Example 12. The method of any one of Examples 1-11, wherein the first mixture is prepared at a temperature between 20° C. and 100° C.

Example 13. The method of any one of Examples 1-12, wherein the first mixture is supplied to the first nozzle at a temperature between 20° C. and 100° C.

Example 14. The method of any one of Examples 1-13, wherein: the directing further comprises concentrically positioning the first nozzle within a second nozzle, and directing a first gas through the second nozzle resulting in the combining of the first gas with the first mixture and the atomizing of the first mixture to form an atomized mixture.

Example 15. The method of any one of Examples 1-14, wherein the directing of the first gas through the second nozzle results in a pressure drop between 100 kPa and 2,000 kPa, between 1,000 kPa and 1,700 kPa, between 400 kPa and 1,000 kPa, or between 140 kPa and 400 kPa.

Example 16. The method of any one of Examples 1-15, wherein the first gas comprises at least one of an inert gas, oxygen, nitrogen, hydrogen, or a combination thereof.

Example 17. The method of any one of Examples 1-16, wherein the inert gas comprises at least one of nitrogen, helium, argon, or a combination thereof.

Example 18. The method of any one of Examples 1-17, wherein the first gas is provided at a temperature between 22° C. and 100° C.

Example 19. The method of any one of Examples 1-18, wherein the directing further comprises applying a voltage potential to at least one of the first nozzle, the second nozzle, or a combination thereof.

Example 20. The method of any one of Examples 1-19, wherein the voltage potential is between 0.1 kV and 100 kV, between 1 kV and 50 kV, or between 5 kV and 15 kV.

Example 21. The method of any one of Examples 1-20, wherein the solvent has a vapor pressure between 0.04 kPa and 100 kPa, between 0.1 kPa and 50 kPa, or between 0.13 kPa and 20 kPa, as measured at 20° C.

Example 22. The method of any one of Examples 1-21, wherein the solvent comprises at least one of water, N-methyl-pyrrolidone (NMP), N,N-dimethylacetamide (DMAc), N,N-dimethylformamide (DMF), dimethoxysulfoxide (DMSO), 1,2-dimethoxyethane (DME, glyme), diethylene glycol dimethyl ether (diglyme), triethylene glycol dimethyl ether (triglyme), tetrahydrofuran (THF), other ethers, ethylene glycol, glycerin, m-cresol, ortho-chlorophenol, chloroform, pyridine, acetonitrile, or a combination thereof.

Example 23. The method of any one of Examples 1-22, wherein the silicon nanoparticles are substantially spherical, cubes, rods, wires, or a combination thereof.

Example 24. The method of any one of Examples 1-23, wherein the silicon nanoparticles have an average particle size between 1 nm and 100 nm, or between 5 nm and 50 nm, or between 5 nm and 30 nm, or between 10 nm and 15 nm.

Example 25. The method of any one of Examples 1-24, wherein: the silicon nanoparticles have a core-shell morphology, the core comprises silicon, and the shell comprises at least one of a molecule, a polymer, a polymer-derived coating, or a combination thereof.

Example 26. The method of any one of Examples 1-25, wherein the shell enables the silicon nanoparticles to be dissolved and/or dispersed in the first mixture.

Example 27. The method of any one of Examples 1-26, wherein the shell comprises an oligomer of polyethylene oxide (PEO).

Example 28. The method of any one of Examples 1-27, further comprising, before the combining, synthesizing the silicon nanoparticles by plasma-enhanced chemical vapor deposition (PECVD).

Example 29. The method of any one of Examples 1-28, wherein the synthesizing results in silicon nanoparticles that have at least one of a single crystalline phase, a polycrystalline phase, an amorphous phase, or a combination thereof.

Example 30. The method of any one of Examples 1-29, wherein the aggregated particles have a maximum average length between 0.1 μm and 50 μm, between 0.1 μm and 25 μm, or between 1.0 μm and 10 μm.

Example 31. The method of any one of Examples 1-30, wherein at least a portion of the aggregated particles are characterized by a toroidal shape.

Example 32. The method of any one of Examples 1-31, wherein the directing further includes mixing the atomized mixture with a second gas at or near the first nozzle and the second nozzle.

Example 33. The method of any one of Examples 1-32, wherein the second gas comprises at least one of an inert gas, hydrogen, or a combination thereof.

Example 34. The method of any one of Examples 1-33, wherein the inert gas comprises at least one of nitrogen, helium, argon, or a combination thereof.

Example 35. The method of any one of Examples 1-34, wherein the second gas is provided at a temperature between 20° C. and 800° C., between 20° C. and 500° C., between 20° C. and 250° C., between 75° C. and 150° C., or between 150° C. and 220° C.

Example 36. The method of any one of Examples 1-35, wherein the first gas is provided at a volumetric to mass ratio of the first gas to the first mixture between 1 L/g and 300 L/g, between 5 and 200 L/g, or between 25 and 100 L/g.

Example 37. The method of any one of Examples 1-36, wherein the precursor comprises a polymer.

Example 38. The method of any one of Examples 1-37, wherein the polymer comprises at least one of an ionically conductive polymer, an electrically conductive polymer, or a combination thereof.

Example 39. The method of any one of Examples 1-38, wherein the polymer comprises at least one of a polyimide, polyacrylonitrile (PAN), a polyphenylmethylimine (polyPMI), a polythiophene, benzene-1,4-dicarboxaldehyde, benzene-1,3,5-tricarboxaldehyde, p-phenylenediamine, an alkyl aldehyde, or a combination thereof.

Example 40. The method of any one of Examples 1-39, wherein the polythiophene is poly(3,4-ethylenedioxythiophene) polystyrene sulfonate (PEDOT:PSS).

Example 41. The method of any one of Examples 1-40, wherein the alkyl aldehyde comprises at least one of hexanal, octanal, decanal, dodecanal, or a combination thereof.

Example 42. The method of any one of Examples 5 through 41, wherein the heating results in the cyclization of PAN, resulting in the forming of a carbonaceous material.

Example 43. The method of any one of Examples 1-42, wherein the heating results in polymerization of the precursor and formation of a carbonaceous material.

Example 44. The method of any one of Examples 1-43, wherein the heating results in at least one of cross-linking, reacting, degrading, or a combination thereof of the precursors and formation of a carbonaceous material.

Example 45. The method of any one of Examples 1-44, wherein the carbonaceous material is the matrix and the aggregated particles comprise the silicon nanoparticles embedded in the carbonaceous matrix.

Example 46. The method of any one of Examples 1-45, wherein the precursor and the silicon nanoparticles are provided to the combining step at a weight ratio (silicon nanoparticles: precursor) between 1:1 and 50:1 or between 70:30 and 95:5.

Example 47. The method of any one of Examples 1-46, wherein, after the heating, at least a portion of the aggregated particles are characterized by a toroidal shape.

Example 48. The method of any one of Examples 1-47, wherein the heating continues in an additional annealing step after the directing step (e.g., spray drying) is complete.

Example 49. The method of any one of Examples 1 through 48, further comprising blending the aggregated particles with a second additive to form a second mixture.

Example 50. The method of any one of Examples 1-49, wherein the second additive comprises at least one of a dispersant, a binder, a thermally conductive additive, an ionically conductive additive, an electrically conductive additive, or a combination thereof.

Example 51. The method of any one of Examples 1-50, wherein the binder comprises at least one of polyacrylic acid, polyimide, polyethyleneimine, polyacrylamide, carboxymethyl cellulose, styrene-butadiene rubber, polyvinylidene fluoride, N,N-methylene bis(acrylamide), tetra (ethylene glycol) diacrylate, or a combination thereof.

Example 52. The method of any one of Examples 1-51, further comprising applying the second mixture to a surface of a conductive metal.

Example 53. The method of any one of Examples 1-52, wherein the conductive metal comprises at least one of copper, gold, silver, molybdenum, aluminum, titanium, or a combination thereof.

Example 54. The method of any one of Examples 1-53, wherein the applying is performed via blade coating, slot die coating, Gravure coating, spray coating, or a combination thereof.

Example 55. A composition comprising: a plurality of aggregated particles comprising silicon nanoparticles embedded within a matrix; wherein a first portion of the aggregated particles is characterized by a structure comprising a continuous peripheral body defining a central recess.

Example 56. The composition of Example 55, wherein the matrix is carbonaceous.

Example 57. The composition of either Example 55 and/or 56, wherein the aggregated particles are porous.

Example 58. The composition of any one of Examples 55-57, wherein the aggregated particles comprise at least one of mesopores, micropores, or a combination thereof.

Example 59. The composition of any one of Examples 55-58, wherein the mesopores comprise pores having a diameter between 2 nm and 50 nm.

Example 60. The composition of any one of Examples 55-59, wherein the micropores comprise pores having a diameter less than 2 nm.

Example 61. The composition of any one of Examples 55-60, wherein the central recess imparts a cup-like structure, a bowl-like structure, or a combination thereof to the aggregated particles.

Example 62. The composition of any one of Examples 55-61, wherein the continuous peripheral body has an irregular profile, an oblong profile, or a combination thereof.

Example 63. The composition of any one of Examples 55-62, wherein the aggregated particles have an average maximum outer dimension between 0.1 μm and 25 μm, between 0.1 μm and 10 μm, or between 0.5 μm and 1.5 μm.

Example 64. The composition of any one of Examples 55-63, wherein the central recess has a maximum outer dimension, for example, between 0.5 μm and 10 μm, between 0.1 μm and 2.0 μm, or between 0.1 μm and 0.5 μm.

Example 65. The composition of any one of Examples 55-64, wherein the central recess extends entirely through the continuous peripheral body to form a central aperture.

Example 66. The composition of any one of Examples 55-66, wherein the aggregated particles further comprise a second portion characterized by substantially spherical primary particles.

Example 67. The composition of any one of Examples 55-66, wherein the second portion has an average diameter between 30 nm and 150 nm.

Example 68. The composition of any one of Examples 55-67, wherein at least a fraction of the second portion is physically connected to the first portion.

Example 69. The composition of any one of Examples 55-68, wherein the aggregated particles further comprise a third population of particles having a morphology selected from the group consisting of an indented sphere, a dimpled sphere, a buckled sphere, and combinations thereof.

Example 70. The composition of any one of Examples 55-69, wherein the silicon nanoparticles are substantially spherical and have an average diameter between 1 nm and 100 nm, between 5 nm and 50 nm, between 5 nm and 30 nm, or between 10 nm and 15 nm.

Example 71. The composition of any one of Examples 55-70, wherein the porous matrix comprises a carbonaceous material.

Example 72. The composition of any one of Examples 55-71, wherein the composition has a silicon to carbon ratio on a weight basis between 1:1 and 50:1.

Example 73. The composition of any one of Examples 55-72, wherein the composition has an average porosity between 0 vol % and 80 vol %, between greater than 0 vol % and 80 vol %, between 5 vol % and 75 vol %, or between 10 vol % and 50 vol %.

Example 74. An electrode comprising a layer of a mixture comprising aggregated particles positioned on a conductive material, wherein the layer has a thickness between 1 μm and 100 μm or between 1 μm and 10 μm.

Example 75. The electrode of Example 74, wherein the mixture further comprises an additive comprising at least one of a dispersant, a binder, a thermally conductive additive, an ionically conductive additive, an electrically conductive additive, or a combination thereof.

Example 76. The electrode of either Example 74 and/or Example 75, wherein the binder comprises at least one of polyacrylic acid, polyimide, polyethyleneimine, polyacrylamide, carboxymethyl cellulose, styrene-butadiene rubber, polyvinylidene fluoride, N,N-methylene bis(acrylamide), tetra (ethylene glycol) diacrylate, or a combination thereof.

Example 77. The electrode of any one of Examples 74-76, wherein the conductive material comprises at least one of carbon, copper, gold, silver, molybdenum, aluminum, titanium, or a combination thereof.

Example 78. The electrode of any one of Examples 74-77, wherein the electrode is characterized by an areal loading between 0.8 mg/cm² and 10 mg/cm², between 0.8 mg/cm² and 5 mg/cm², or between 0.98 mg/cm² and 1.19 mg/cm².

Example 79. The electrode of any one of Examples 74-78, wherein the electrode is characterized by a specific capacity of the electrode at C/10 between 1000 mAh/g and 2000 mAh/g or between 1100 mAh/g and 1390 mAh/g.

Example 80. The electrode of any one of Examples 74-79, wherein the electrode is characterized by a specific capacity normalized to Si at C/10 between 1400 mAh/g Si and 1700 mAh/g Si or between 1510 mAh/g Si and 1682 mAh/g Si.

Example 81. The electrode of any one of Examples 74-80, wherein the electrode is characterized by a silicon utilization at C/10 between 75% and 99% or between 83% and 90%.

Example 82. The electrode of any one of Examples 74-81, wherein the electrode is characterized by a 6 C capacity retention relative to C/10 between 30% and 70% or between 51% and 61%.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, +5%, or +1% of a specific numeric value or target. In some embodiments of the present invention, the term “about” is used to indicate an uncertainty limit of less than or equal to +1%, ±0.9%, ±0.8%, ±0.7%, ±0.6%, +0.5%, 0.4%, +0.3%, ±0.2%, or +0.1% of a specific numeric value or target.

The foregoing discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

What is claimed is:

1. A composition comprising a plurality of aggregated particles comprising silicon nanoparticles embedded within a matrix.

2. The composition of claim 1, wherein a portion of the aggregated particles is characterized by a structure comprising a continuous peripheral body defining a central recess.

3. The composition of claim 1, wherein the matrix is carbonaceous.

4. The composition of claim 1, wherein the aggregated particles are porous.

5. The composition of claim 1, wherein the central recess imparts a cup-like structure, a bowl-like structure, or a combination thereof to the aggregated particles.

6. The composition of claim 1, wherein the continuous peripheral body has an irregular profile, an oblong profile, or a combination thereof.

7. The composition of claim 1, wherein the aggregated particles have an average maximum outer dimension between 0.1 μm and 50 μm.

8. The composition of claim 1, wherein the central recess has a maximum outer dimension between 0.1 μm and 25 μm.

9. The composition of claim 1, wherein the central recess extends entirely through the continuous peripheral body to form a central aperture.

10. The composition of claim 3, wherein the composition has a silicon to carbon mass ratio between 1:1 and 50:1.

11. The composition of claim 4, wherein the composition has an average porosity between 0 vol % and 80 vol %.

12. An electrode comprising a layer of a mixture comprising aggregated particles positioned on a conductive material, wherein the layer has a thickness between 1 μm and 100 μm.

13. The electrode of claim 12, wherein the mixture further comprises an additive comprising at least one of a dispersant, a binder, an ionically conductive additive, an electrically conductive additive, or a combination thereof.

14. The electrode of claim 12, wherein the electrode is characterized by an areal loading between 0.8 mg/cm² and 10.0 mg/cm².

15. The electrode of claim 12, wherein the electrode is characterized by a specific capacity of the electrode at C/10 between 1000 mAh/g and 1500 mAh/g.

16. The electrode of claim 12, wherein the electrode is characterized by a specific capacity normalized to Si at C/10 between 1400 mAh/g Si and 2000 mAh/g Si.

17. The electrode of claim 12, wherein the electrode is characterized by a silicon utilization at C/10 between 75% and 99%.

18. The electrode of claim 12, wherein the electrode is characterized by a 6 C capacity retention relative to C/10 between 30% and 70%.

19. A method comprising:
combining silicon nanoparticles and a precursor to form a first mixture, wherein:
the combining results in the forming of aggregated particles comprising the silicon nanoparticles embedded in a matrix derived from the precursor.

20. The method of claim 19, further comprising, during the combining and/or after the combining, heating the silicon nanoparticles and the precursor to a temperature between 20° C. and 800° C.

21. The method of claim 20, wherein:
the first mixture further includes a solvent and the combining results in the forming of at least one of a slurry, a solution, or a combination thereof, prior to the forming of the aggregated particles.

22. The method of claim 21, wherein the combining further comprises directing the first mixture through a first nozzle.
